(19) United States
(12) Patent Application Publication
(10) Pub. No.: US 2012/0251798 A1
(43) Pub. Date: Oct. 4, 2012

(54) SILICONE CAP LAYER LAMINATES

(76) Inventor: Yan Chen, Canton, OH (US)

(21) Appl. No.: 13/439,323

(22) Filed: Apr. 4, 2012

Related U.S. Application Data
(60) Provisional application No. 61/471,357, filed on Apr. 4, 2011.

(51) Int. Cl. B32B 3/10; B32B 5/02; D04B 1/00; D03D 15/00; D04B 1/14; D04H 3/004; B32B 5/18; B32B 17/04

(52) U.S. Cl. 428/196; 428/206; 428/304.4; 428/311.11; 428/339; 428/396; 442/181; 442/304; 442/327

(57) ABSTRACT

A soft feel decorative, textured laminate used for various vertical surfaces of the interior of commercial aircraft. Fire resistant silicone materials are used as a cap layer on various substrates including FR resin impregnated woven glass and naturally high flammability resistance polymer film. The FR-silicone cap layer can be used on various substrates, such as polymeric film, polymeric sheet, foam fabric materials, woven/non-woven and knitted glass. The FR-silicone cap layer can be colored or combined with prints. A clear silicone layer can be laminated on top of a printed silicone layer to protect the print and provide better abrasion resistance. The silicone laminate passes FAA and OEM interior aircraft flammability requirements including heat release, smoke and vertical burn.

### RELATED APPLICATIONS

This application claims priority to U.S. Provisional Patent Application No. 61/471,357, filed on Apr. 4, 2011, which is incorporated herein by reference in its entirety.

### FIELD OF THE INVENTION

The present invention relates to decorative laminates and more specifically to a soft feel decorative laminate with a silicone surface layer.

### BACKGROUND OF THE INVENTION

Silicones are organic/inorganic hybrid polymers. Silicones are highly valued materials because they have a combination of physical properties not found in other polymers. They have outstanding heat stability (service temperature can be as high as 200° C.) and can be used in applications where organic materials would melt or decompose. Silicone materials can be fabricated by extrusion, injection molding, compression molding, casting and calendar. Silicone polymers or resins can be regarded as already partially oxidized as they consist partially of Si—O group. This is one of the reasons for the high thermal stability of silicones compared to organic materials.

The position of silicon, just under carbon in the periodic table, led to a belief in the existence of analogue compounds where silicone would replace carbon. Most of these analogue compounds do not exist, or if they do, they behave very differently. Between any given element and silicon, bond lengths are longer than for carbon with this element. The lower silicon electronegativity (1.8) vs. carbon (2.5) leads to a very polarized Si—O bond, highly ionic and with a large bond energy (452 kj/mole). The Si—C bond has a bond energy slightly lower than a C—C bond, while Si—Si bond is weak. Silicone atoms do not form stable double or triple bonds with other elements. The inorganic backbone of Si—O—Si is highly flexible because low rotation and cohesive energy, while hydrocarbon polymer has a relative rigid backbone. The pendant group also kept apart by spacing because the Si atom is bigger than C. Due to the flexibility of the silicone backbone the glass transition typically occurs below −120° C., a remarkably low temperature if compared to other polymers. The very polarized Si—O would lead to strong intermolecular interaction if weakly interacting with each other methyl group is not attached to the Si—O backbone to shield the main chain. That's also the reason that these very organic side groups are often associated with low surface energy made silicone a low surface tension material. The low intermolecular interaction in silicones creates a high free volume compared to hydrocarbons and explains the high solubility and high diffusion coefficient of gas into silicones. Silicones have a high permeability to oxygen, nitrogen and water vapor although liquid water is not capable of wetting a silicone surface due to very hydrophobic methyl groups pointing to the outside.

The activation energy to the viscous silicone movement is very low and viscosity is less dependent on temperature compared to hydrocarbon polymers. Therefore it's more dependant on molecular weight.

There are four major types of pendants group commonly used on the back bone of Si—O. They are methyl, vinyl, phenyl and trifluoropropyl. The first three group silicones are resistance to hydrocarbon but not resistance to ketone type of solvent. The last group silicone is considered as solvent resistant material in general but not very good resistance to hydrocarbon. Sometime multi-pendant groups are used to achieve the final application needs.

In aqueous media, Si—O bonds are more susceptible to hydrolysis than C—C bonds, especially in the presence of an acid or base. This might suggest that silicone would be expected to show less resistance to weathering than organic resins.

Based on literature search, almost all forms of silicon have been explored as flame retardants with two approaches: 1) Mix low percentage of Si-based material with organic polymer and 2) Incorporation of silicon into the branches of polymer chains.

When silicone are under flame a gray, coarse and which SiO2 is formed and burned slowly with little or no swelling of the residue. This is in contrast to PVC burns that a more voluminous, very strong, largely black char is formed.

Silicone is also used in the skin care formulation because the unique skin feel and is often described as smooth, silky, elegant or luxurious. Increasing the length of chain leads to silicone gums, which have been characterized as giving a velvety feel. Cross-linked silicone elastomer dispersions exhibit a further differentiated feel, which can be described as silky or powdery.

Silicone materials show no toxicity during administration via typical exposure routes and no hazard to humans. The synthesis of silicone materials does not require heavy metal catalysts or organic solvents. At the end of service life of silicones the materials will be either land filled or incinerated. In the latter case, they are converted back to inorganic ingredients, amorphous silica, carbon dioxide and water vapour.

### SUMMARY OF THE INVENTION

The present disclosure and related inventions are directed to a soft feel decorative laminate with silicone as a surface layer for use in the field of aviation. The decorative laminate feels like leather or rubber and has a soft durometer rating and soft feel and may be textured and customer colored. This type of material is easily achieved in non-aviation applications due to the low flammability requirements. However, in aviation applications, strict FAA and OEM flammability requirements such as smoke and heat release must be met. The laminate can be used for bulkhead class dividers, first class seats, window panels, etc.

The decorative laminate of the present invention is a solution utilizing fire resistant silicone materials as a cap layer on various substrates including FR resin impregnated woven glass and naturally high flammability resistance polymer film. The resulting FR-silicone film can be used as a cap layer (the thickness of silicone film will be controlled by the texture depth required by the customer and in general can be between 3 mil to 10 mil) on various substrates such as polymeric film, polymeric sheet, foam, fabric materials, woven/non-woven and knitted glass. The FR-silicone cap layer can be colored or combined with prints. A clear silicone layer can be laminated on top of a printed silicone layer to protect the print and provide better abrasion resistance.

### DETAILED DESCRIPTION OF PREFERRED AND ALTERNATE EMBODIMENTS

Arlon prototype silicone NTF has thickness of 62 mils and a balanced construction on 162 style fiberglass (12 oz/yard, 2 plain weave). On one side of fiberglass is a red/brown fusible silicone rubber compound that is 100% cured. The other side of the fiberglass layer is a gray flame resistant, high tear strength compound that is uncured and designed to be embossed and to cure the silicone at the same time with heat.

The fully cured red/brown silicone rubber side is designed to slowly fuse (bond) to a seaming tape. Full bond develops over 24 to 48 hour at room temperature. The seaming tape has the same fusible silicone rubber on one side and an acrylic PSA on the other. The PSA is also designed as repositionable during installation and once fully fused between NTF and one side of seaming tape a solid homogeneous piece of silicone rubber will be formed.

In one embodiment, a silicone rubber impregnated fiberglass is used a second embodiment is produced with silicone resin impregnated fiberglass in order to increase the rigidity of NTF. A coupling agent package was can be added to promote adhesion to the silicone resin impregnated fiberglass support.

Evaluation data of Arlon silicone VS Metzeler silicone, Aerfusion eco and Aermat 9500 BP are shown in Table 1. The Metzeler and Eco materials have rigid backing. The use of Arlon silicone NTF and AerMat 9500BP is disclosed. The tear strength of Arlon silicone NTF actually is better than AerMat as well as Metzeler silicone NTF with rigid backing.

In 12S VB, the burn length of silicone material usually is much shorter than PVC or Eco materials but higher on after flame. Extra FR additives are needed in order to decrease after flame burning.

TABLE 1
Arlon and Metzeler Silicone NTF VS AerFusion eco and AerMat

| | | | | | | | | | AerMat | | |
|---|---|---|---|---|---|---|---|---|---|---|---|
| | | | | | | | Arlon NTF | Arlon NTF | AM | Metzeler | Aerfusion |
| | | | | Test | | | Dec. 20, 2008 | Apr. 20, 2009 | 9500BP | Airflex | eco |
| Properties | | | | Methods | Specification | Units | R38366X060 | R38558X060 | Air Astana | 62 | RKG 621 |
| 1 | Thickness | | | ISO 2286-3 | | mm | 1.55 | 1.54 | 1.71 | 2.13 | 1.46 |
| 2 | Total mass per unit area | | | ISO 2286-2 | | g/m² | 2026 | 2028 | 2211 | 2100 | 1933 |
| 3 | Static coefficient | dry | 92R | ISO 8295 | 0.25 min. | | 0.839 | | 0.758 | | 0.82 |
| | of friction | wet | 92R | | 0.25 min. | | 0.53 | | 0.645 | | 0.71 |
| | Dynamic | dry | 92R | | 0.25 min. | | 0.804 | | 0.431 | | 0.73 |
| | coefficient of | wet | 92R | | 0.25 min. | | 0.524 | | 0.451 | | 0.62 |
| | friction | | | | | | | | | | |

| 4 | Dimensional stability | | EN 434 | 0.2 max. | % | | 0 | 0 | 0 | 0 |
|---|---|---|---|---|---|---|---|---|---|---|
| 5 | Curling | | | max. 10 | mm | | | | 3.25 | |
| 6 | Abrasion - Loss In mass | | ISO 9352 | 1000 max. | mg | 151.1 | | 324 | 140 | 204 |
| 7 | Tear strength | MD | ISO 4674-1 | 60 min. | N | 75 | | 44 | 42 | 186 |
| | | CMD | method A | 60 min. | N | | | 54 | 50 | 181 |

| 8 | Peel resistance with fused tape | | | | | 19.5 | | | |
|---|---|---|---|---|---|---|---|---|---|
| 9 | Weldability (fused with seaming | | EN 684 | 250 min. | N/50 mm | 633 | | | 361 |
| | tape of Arlon NTF, Eco with | | | | | | | | |
| | PVC welding rod) | | | | | | | | |
| 10 | Weldability with Metzeler silicone | | EN 684 | 250 min. | N/50 mm | | | 885* | |
| | welding rod | | | | | | | | |
| 11 | Stain resistance | citric acid | ISO 4586-2 | RATING 5 | | 5 | 5 | | 5 |
| | against | 10% solution | clause 16 | RATING 5 | | 5 | 5 | | 5 |
| | | alcoholic | procedure A | RATING 5 | | 5 | 5 | | 5 |
| | | beverages red | | | | | | | |
| | | urea 20% | | | | | | | |
| | | solution | | | | | | | |

| 12 | Residual indentation | | EN 433 | | mm | | 0.02 | 0.03 | 0.05 | 0.05 |
|---|---|---|---|---|---|---|---|---|---|---|
| 13 | Flammability, vertical | 12S | AITM | 203, 15, 5 | mm, s, s | 4, 10, 0 | 5, 16, 0 | 128, 9, 0 | 4, 8, 0 | 46, 4, 0 |
| | | | 2.0002B | | | | | | | |

| | | | | | |
|---|---|---|---|---|---|
| 14 | NBS Smoke density at 4 min | AITM 2.007 | <200 | 52 | 121 |

| | | | | | | | |
|---|---|---|---|---|---|---|---|
| 15 | Hardness | Shore A | 80 | 75 | 81 | 75 | 85 |
| | (Durometer) | | | | | | |

*material came out of grips before coming apart

Silicone material has lower NBS smoke than Eco materials. The toxicity testing was not performed on silicone since silicone burning will not generate any HCl, HF, HCN, SOx or NOx.

When two pieces of Arlon silicone NTF are fused together with fusable tape, the peel resistance between NTF and tape had low strength value of 19.5 N/25 mm but the weldability (using Airbus term) as tensile strength between the two piece of NTF joined by tape is much higher (633 N/50 mm) than Airbus spec 250 N/50 mm.

From the Airbus slip testing method there are no reasons to suggest silicone would be a slippery materials as surface of NTF. The Shore A hardness of all these NTF are between 75 and 85.

The following Bisco silicone samples were also tested:

| | | | | |
|---|---|---|---|---|
| HT800, | medium | Rogers | 31 mil, | Apr. 12, 2009 |
| | cellular silicone | | 12″ × 30″ | |
| H6360, | FR solid | Rogers | 20 mil, | Apr. 12, 2009 |
| | silicone | | 12″ × 30″ | |
| HT6240, | transparent, | Rogers | 10 mil, 10″ × 12″ | Apr. 12, 2009 |
| | solid | | | |
| HT6135 | cream, solid | Rogers | 10 mil, 10″ × 12″ | Apr. 12, 2009 |

We built NTF type lab construction with Roger silicone as indicated in table 2. DLC-503 is a double liner supported laminating adhesive from JDC coating Inc. This is an acrylic/silicone laminating adhesive and designed for laminating silicone with other polymers without the use of a flammable primer. Bisco HT-6360 was used as cap layer of our Eco in construction 1. Construction 2 uses the hybrid woven of Ultem and glass as rigid backing.

TABLE 2
Lab construction with Rogers silicone:

| | | | | 92R texture | 690 texture |
|---|---|---|---|---|---|
| | | | | HT-6360, | HT-6240, |
| | | | | 20 mil FR-silicone | 10 mil transparent, non-FR |
| | | | | DLC 503 | DLC 503 |
| | | | | Eco base | UItem/glass |
| Properties | Test Methods | Specification | Units | Construction 1 | Construction 2 |
| Thickness | ISO 2286-3 | max 148 | mil | 64 | 27 |
| Flammability, | AITM 2.0002B | 203, 15, 5 | mm, s, s | 6, 8.3, 0 | burned on top layer |
| vertical, 12 s | | | | | |
| 12S VB | AITM 2.0002B | 15 | sec. | 5.1 | 19.07 |
| extg. time 1 | | | | | |
| 12S VB | AITM 2.0002B | 15 | sec. | 10.2, 9.6 | 23 |
| extg. time 2 | | | | | |
| 12S VB | AITM 2.0002B | 15 | sec. | 8.3 | 21 |
| extg. time ave. | | | | | |

The very limited 12S VB data of table 2 emphases again that silicone does pass 12S VB in construction one but 8.3 S after flame is too close to the specification of 15S and may need FR additives in order to be useful in the industry we serve. A transparent silicone HT-6240 without FR will not pass even 12S VB. Silicone with FR in general is very difficult to maintain the transparency. The construction 1 with solid color cap layer of HT-6360 on Eco was evaluated just for combustion characteristics.

Laminates (Arlon and Rogers Silicone)

Silicone has been used in functional laminates like vibration-isolating laminate (Dow Corning Toray Silicone), soil resistant curable laminate (3M Innovative properties co) etc. To use silicone as decorative laminate with a soft feel is novel. The surface energy of any substance is a direct manifestation of the intermolecular forces between molecules. The organic portion methyl group of silicone provides the weakest possible forces (only aliphatic fluorocarbon groups are lower). The most flexible inorganic siloxane backone allows the methyl groups to be arranged easily. Both join together results in a low surface energy polymer that can be improved only by more expensive fluorocarbon polymers. This unique surface behavior is advantageous for a decorative laminate.

Table 3 sets forth data or 1 mil HA211 bound to Al-substrate for all the testing:

TABLE 3
Arlon silicone in Aerfilm/Aertrim type of construction

| | | | | | | | | 3 | | | |
|---|---|---|---|---|---|---|---|---|---|---|---|
| | | | | | | 1 | | 8 mil silicone | | | 6 |
| | | | | | | 8 mil silicone | 2 | on 1 mil WT | | | 7 mil |
| | | | | | | on 1 mil WT | 8 mil silicone | and capped | 4 | 5 | silicone |
| | | | | | | and capped | on 1 mil WT | with 1 mil GT | 5 mil | 10 mil | on 7628 |
| | | Test | | FAA | Airbus | with 1 mil GT | Aug. 14, 2009 | Aug. 14, 2009 | silicone | silicone | glass |
| Properties | | Methods | Units | req. | req. | Jul. 10, 2009 | 09DT0069A | 09DT0069A | Oct. 10, 2009 | | |
| 1 | Thickness | ISO 2286-3 | mil | | | 11 | 11 | 12 | 5.7 | 11.5 | 13.3 |
| 2 | Total mass per | ISO 2286-2 | g/m² | | | | 338 | 380 | 148 | 306 | 426 |
| | unit area | | | | | | | | | | |
| 3 | OSU peak | Avs | kw/m² | 65 | 35 to 50 | 175 | 160.4 | 151.5 | 63.4 | 77.4 | 62.6 |
| 4 | OSU total 2 min | Avs | kw-min/m2 | 65 | 35 to 50 | 72 | 62.5 | 74.3 | 23.6 | 36 | 29.6 |
| | NBS smoke at | | | 200 | 100 to 130 | | | 123.7 | | | |
| | Max | | | | | | | | | | |

Construction 1 and 3—An 8 mil Arlon uncured silicone was directly coated on 1 mil white Tedlar (WT). In our lab we used lab press to cure, emboss and laminate 1 mil glossy Tedlar (GT) with the silicone at 350 F/5 min/175 psi. Construction 3 is a repeat experiment of construction 1. These two constructions are thicker and heavier than our current Aerfilm in order to accommodate a deeper texture that was provided by PVC plastisol before but could not continuously produce because failing on FST. Obviously the peak heat release of this construction is much higher than the OEM specification. A thinner silicone coating can be achieved based on Arlon feedback.

Construction 2 is an 8 mil silicone on white Tedlar without glossy Tedlar cap. After the embossing the silicone material provides rubber feel—a very different tactile impression than our current Aerfilm. Arlon silicone had very good adhesion to Tedlar with current adhesives. The high heat release lead us to evaluate the following three constructions.

Construction 4, 5 and 6 are tested without Tedlar. Construction 6 is similar to Aertrim but lighter. All these evaluations demonstrated a key point—silicone can provide a soft feel surface in laminates and can be optimized to reduce peak heat release.

Table 4 compares Bisco silicone 30 mil of FR-cellular HT-800, 20 mil solid FR-silicone of HT-6360 FR-TPU Ultrach 7000 soft materials. The tests were done on Al-substrate with HA211. They all pass 60S VB. TPU had much higher smoke density and peak heat release than silicone. Bisco silicone is also too high on peak heat release if a 20 mil deep texture is needed. Roger was not willing to make customer blends for us and would not provide un-cured silicone at that time.

TABLE 4
Rogers silicone comparing with FR-polyurethane

| | | | | Ultratch, FR-TPU | Roger silicone | |
|---|---|---|---|---|---|---|
| | | | | fabric backing | | cellular |
| | Properties | | Units | Ultratch7000 | HT-6360 | HT-800 |
| 1 | Thickness | | mil | 25 | 20 | 31 |
| 2 | Flammability, vertical | 60S | mm, s, s | 67, 0, 0 | 31, 0, 0 | 40, 0, 0 |
| 3 | OSU peak | Avs | kw/m² | 112 | 79 | 66 |
| | OSU total 2 min | Avs | kw-min/m² | 43 | 45 | 54 |
| 4 | NBS smoke at 4 min | | | 213 | 21 | 28 |
| | NBS smoke at Max | | | 213 | 21 | 28 |
| 5 | Shore A hardness | | | 81 | 85 | |

What is claimed is:

1. A soft feel decorative laminate comprising:
a substrate selected from the group consisting of: polymeric film, foam, thermoplastic sheet , woven glass, non-woven glass, knitted fabric and knitted glass; and
a cap layer comprising fire-resistant silicone and a fire-resistant resin impregnated fiberglass.

2. The soft feel decorative laminate of claim 1, wherein the thickness cap layer is approximately between 3 and 10 mil.

3. The soft feel decorative laminate of claim 1, wherein the cap layer is colored.

4. The soft feel decorative laminate of claim 1, wherein the cap layer is combined with prints.

5. The soft feel decorative laminate of claim 4 further comprising a clear silicone layer laminated on top of the printed silicone layer to protect the print and provide abrasion resistance.

6. The soft feel decorative laminate of claim 1, wherein the laminate meets the FAA interior aircraft flammability requirements including heat release, smoke and vertical burn.

7. The soft feel decorative laminate of claim 1, wherein the laminate meets the OEM interior aircraft flammability requirements including heat release, smoke and vertical burn.

8. The soft feel decorative laminate of claim 1, wherein the laminate is suitable for use as aviation bulkhead class dividers, first class seats, and window panels.

9. A soft feel decorative laminate comprising:
a substrate selected from the group consisting of: polymeric film, polymeric sheet, foam fabric materials, woven glass, non-woven glass and knitted glass;
a cap layer comprising fire resistant silicone and a fire-resistant rubber impregnated fiberglass.

10. The soft feel decorative laminate of claim 9, wherein the thickness cap layer is approximately between 3 and 10 mil.

11. The soft feel decorative laminate of claim 9, wherein the cap layer is colored.

12. The soft feel decorative laminate of claim 9, wherein the cap layer is combined with prints.

13. The soft feel decorative laminate of claim 12 further comprising a clear silicone layer laminated on top of the printed silicone layer to protect the print and provide abrasion resistance.

14. The soft feel decorative laminate of claim 9, wherein the laminate meets the FAA interior aircraft flammability requirements including heat release, smoke and vertical burn.

15. The soft feel decorative laminate of claim 9, wherein the laminate meets the OEM interior aircraft flammability requirements including heat release, smoke and vertical burn.

16. The soft feel decorative laminate of claim 9, wherein the laminate is suitable for use as aviation bulkhead class dividers, first class seats, and window panels.
